(19) United States
(12) Patent Application Publication
(10) Pub. No.: US 2014/0090480 A1
(43) Pub. Date: Apr. 3, 2014

(54) TESTING AND MEASURING DEVICES, SYSTEMS, COMPONENTS AND METHODS

(71) Applicants: Changqing W. Adams, Fort Mill, SC (US); Mark W. Ferebee, Charlotte, NC (US)

(72) Inventors: Changqing W. Adams, Fort Mill, SC (US); Mark W. Ferebee, Charlotte, NC (US)

(21) Appl. No.: 13/879,683

(22) PCT Filed: Oct. 20, 2011
(86) PCT No.: PCT/US11/57068

§ 371 Date: Apr. 16, 2013

Related U.S. Application Data
(60) Provisional application No. 61/405,756, filed on Oct. 22, 2010.

(51) Int. Cl. G01N 3/00

(52) U.S. Cl. CPC G01N 3/00
USPC 73/818

(57) ABSTRACT

The embodiments are directed to high precision Micro-Penetration Strength Testers, high pressure Micro-Compression Testers, and/or the like adapted for testing non-conductive thin films or membranes and coated films or coated membranes. At least certain embodiments are directed to Z-direction mechanical and/or insulation strength test methods, devices, instruments, equipment, apparatus, and/or systems, Micro-Penetration Strength Testers adapted for testing thin films, Micro-Compression Testers adapted for testing thin films, high precision Nano Testers for testing non-conductive or semi-conductive materials, films, coatings, coated films, and/or the like, Nano-Penetration Strength Testers, Nano-Compression Testers, Z-Direction Strength Testers, improved indenter tips, micro indenter tips, nano indenter tips, indenter tips for converting a Micro- or Nano-Penetration Strength Tester into a Micro- or Nano-Compression Tester, and/or the methods of converting Micro-Penetration Strength Testers into Micro-Compression Testers.

### CROSS-REFERENCE TO RELATED APPLICATIONS

The present application claims priority to and the benefit of U.S. provisional patent application Ser. No. 61/405,756, filed Oct. 22, 2010, to Adams et al., which is hereby fully incorporated by reference herein.

### FIELD OF THE INVENTION

In accordance with at least selected embodiments, the present invention is directed to testing and/or measuring devices, instruments, equipment, apparatus, systems, components, and/or methods, mechanical and/or insulation strength testing and/or measuring devices, instruments, equipment, apparatus, systems, components, and/or methods, Z-direction or thickness-direction testing and/or measuring devices, instruments, equipment, apparatus, systems, components, and/or methods, Z-direction or thickness-direction strength testing and/or measuring devices, instruments, equipment, apparatus, systems, components, and/or methods, Z-direction or thickness-direction micro-penetration testing and/or measuring devices, instruments, equipment, apparatus, systems, components, and/or methods, and/or Z-direction test methods, devices, instruments, equipment, apparatus, and/or systems. In accordance with at least certain embodiments, the present invention is directed to non-conductive or semi-conductive materials, coatings or coated materials Z-direction testing and/or measuring methods, devices, instruments, equipment, apparatus, systems, and/or components, and/or non-conductive or semi-conductive materials, coatings or coated materials Z-direction test methods, devices, instruments, equipment, apparatus, and/or systems. In accordance with at least particular embodiments, the present invention is directed to non-conductive, polymer material, film or coating Z-direction testing and/or measuring methods, devices, instruments, equipment, apparatus, systems, and/or components, and/or non-conductive, polymer material, film or coating Z-direction test methods, devices, instruments, equipment, apparatus, and/or systems. In accordance with at least possibly preferred embodiments, the present invention is directed to non-conductive, polymer material, film, composite, or coated film Z-direction testing and/or measuring methods, devices, instruments, equipment, apparatus, systems, and/or components, and/or non-conductive, polymer material, film, composite, or coated film Z-direction test methods, devices, instruments, equipment, apparatus, and/or systems. In accordance with at least selected possibly preferred embodiments, the present invention is directed to porous, non-conductive, polymer material, film, composite, or coated film Z-direction test methods, devices, instruments, equipment, apparatus, and/or systems. In accordance with at least certain possibly preferred embodiments, the present invention is directed to porous, macroporous and/or microporous, non-conductive and/or semi-conductive, single or multi-layer, material, film, composite, laminate, or coated material, film, composite, laminate, or the like testing and/or measuring methods, devices, instruments, equipment, apparatus, systems, and/or components, and/or Z-direction test methods, devices, instruments, equipment, apparatus, and/or systems. In accordance with at least particular possibly preferred embodiments, the present invention is directed to thin film Z-direction test methods, devices, instruments, equipment, apparatus, and/or systems. In accordance with at least certain particular possibly preferred embodiments, the present invention is directed to thin film Z-direction strength, penetration, compression, micro penetration, and/or micro compression test methods, devices, instruments, equipment, apparatus, and/or systems. In accordance with at least selected particular possibly preferred embodiments, the present invention is directed to high precision Micro-Penetration Strength Testers adapted for testing non-conductive thin films or membranes, and/or coated films or coated membranes, Micro-Compression Testers adapted for testing non-conductive thin films or membranes, and/or coated films or coated membranes, and/or the like. In accordance with at least selected certain particular possibly preferred embodiments, the present invention is directed to a high precision Micro-Penetration Strength Tester adapted for testing thin films, non-conductive thin films or membranes, and/or coated films or coated membranes, a high pressure Micro-Compression Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro Z-Direction Strength Tester adapted for testing thin films, non-conductive thin films or membranes, and/or coated films or coated membranes, a high precision Micro Z-Direction Tester adapted for testing thin films, non-conductive thin films or membranes, and/or coated films or coated membranes, and/or the like, a high precision Micro Tester adapted for testing thin films, non-conductive thin films or membranes, and/or coated films or coated membranes, a high precision Z-Direction Tester adapted for testing thin films, non-conductive thin films or membranes, and/or coated films or coated membranes, and/or the like. In accordance with at least selected other particular possibly preferred embodiments, the present invention is directed to high precision Nano Testers for testing non-conductive or semi-conductive materials, films, coatings, coated films, and/or the like, a Nano-Penetration Strength Tester adapted for testing thin films, non-conductive thin films or membranes, and/or coated films or coated membranes, a Nano-Compression Tester adapted for testing thin films, non-conductive thin films or membranes, and/or coated films or coated membranes, a high precision Nano-Penetration and/or Nano-Compression Tester adapted for testing thin films, non-conductive thin films or membranes, and/or coated films or coated membranes, and/or the like, a high precision Nano Z-Direction Strength Tester adapted for testing thin films, non-conductive thin films or membranes, and/or coated films or coated membranes, a high precision Nano Z-Direction Tester adapted for testing thin films, non-conductive thin films or membranes, and/or coated films or coated membranes, and/or the like, a high precision Nano Strength, Penetration and/or Compression Tester adapted for testing thin films, non-conductive thin films or membranes, and/or coated films or coated membranes, and/or the like. In accordance with at least certain selected particular possibly preferred embodiments, the present invention is directed to new or improved indenter tips, micro indenter tips, nano indenter tips, an indenter tip for converting a Micro-Penetration Strength Tester into a Micro-Compression Tester, an indenter tip for converting a Nano-Penetration Strength Tester into a Nano-Compression Tester, and/or the like. In accordance with at least selected certain particular possibly preferred embodiments, the present invention is directed to a high precision Micro-Penetration Z-Direction Strength Tester adapted for testing thin films, non-conductive thin films or membranes, and/or coated films or coated membranes, a high precision Micro-Compression Z-Direction Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro-Penetration and/or Micro-Compression Z-Direction Tester adapted for testing thin films, non-conductive thin films or membranes, and/or coated films or coated membranes, and/or the like. In accordance with at least certain other selected particular possibly preferred embodiments, the present invention is directed to methods of converting Micro-Penetration Strength Testers into Micro-Compression Testers, methods of converting Micro-Compression Testers into Micro-Penetration Strength Testers, methods of converting a Micro-Penetration Strength Tester into a Micro-Compression Tester by changing the indenter tip, by changing the shape of the indenter tip, and/or the like. In accordance with at least certain other selected particular possibly preferred embodiments, the present invention is directed to methods of converting Nano-Penetration Strength Testers into Nano-Compression Testers, methods of converting Nano-Compression Testers into Nano-Penetration Strength Testers, methods of converting a Nano-Penetration Strength Tester into a Nano-Compression Tester by changing the indenter tip, by changing the shape of the indenter tip, and/or the like.

### BACKGROUND OF THE INVENTION

The particle or micro particle penetration or compression strength of non-conductive films or non-conductive coated films is of interest to, for example, semi-conductor, electronics, aero-space, medical, plastics, energy storage, and coating manufacturers. Traditional test methods to determine the penetration or compression strength of a film typically may involve the use of a bottom plate, and an indenter shaped like a flat ended rod, spike, or ball to compress or penetrate a sample with or without particles until the sample breaks. Depending on the shape or uniformity of the particles being used, the end point detection mechanism, the indenter, the surface of the bottom plate and/or the like, at least certain of these approaches may have issues with poor repeatability, inconsistency, or other potential difficulties.

There exists a need for an improved, unique, or specialized method, device, instrument, equipment, apparatus, and/or system for at least certain applications, materials, and/or the like, to conduct standardized penetration or compression testing, to conduct standardized micro particle penetration testing without the use of particles, for specialized particle micro penetration testing without the use of particles, for repeatable and/or consistent micro particle penetration testing without the use of particles, for repeatable and/or consistent standardized micro particle penetration testing without the use of particles, to conduct standardized micro compression testing, to conduct standardized Z-direction testing with improved testing methods, devices, instruments, equipment, apparatus, and/or systems, and/or the like.

### SUMMARY OF THE INVENTION

At least selected embodiments of the present invention or inventions address the need for an improved, unique, or specialized method, device, instrument, equipment, apparatus, and/or system for at least certain applications, materials, and/or the like, to conduct standardized micro penetration or compression testing, to conduct standardized micro particle penetration testing without the use of particles, for specialized micro particle penetration testing without the use of particles, for repeatable and/or consistent micro particle penetration testing without the use of particles, for repeatable and/or consistent standardized micro particle penetration testing without the use of particles, to conduct standardized micro compression testing, to conduct standardized Z-direction testing with improved testing methods, devices, instruments, equipment, apparatus, and/or systems, and/or the like.

At least certain embodiments of the present invention are directed to or provide a proven design, method, device, instrument, equipment, apparatus, and/or system to conduct standardized micro penetration or compression testing, to conduct standardized micro particle penetration testing without the use of particles, for specialized micro particle penetration testing without the use of particles, for repeatable and/or consistent micro particle penetration testing without the use of particles, for repeatable and/or consistent standardized micro particle penetration testing without the use of particles, to conduct standardized micro compression testing, for repeatable and/or consistent compression testing, for repeatable and/or consistent standardized micro compression testing, to conduct standardized Z-direction testing, for repeatable and/or consistent Z-direction testing, for repeatable and/or consistent standardized Z-direction testing, and/or improved testing methods, devices, instruments, equipment, apparatus, and/or systems, and/or the like.

In accordance with at least selected embodiments, the present invention is directed to Z-direction test methods, devices, instruments, equipment, apparatus, and/or systems. In accordance with at least certain embodiments, the present invention is directed to non-conductive or semi-conductive materials, coatings or coated materials Z-direction test methods, devices, instruments, equipment, apparatus, and/or systems. In accordance with at least particular embodiments, the present invention is directed to non-conductive, polymer material, film or coating Z-direction test methods, devices, instruments, equipment, apparatus, and/or systems. In accordance with at least possibly preferred embodiments, the present invention is directed to non-conductive, polymer material, film, composite, or coated film Z-direction test methods, devices, instruments, equipment, apparatus, and/or systems. In accordance with at least selected possibly preferred embodiments, the present invention is directed to porous, non-conductive, polymer material, film, composite, or coated film Z-direction test methods, devices, instruments, equipment, apparatus, and/or systems. In accordance with at least certain possibly preferred embodiments, the present invention is directed to porous, macroporous and/or microporous, non-conductive and/or semi-conductive, single or multi-layer, material, film, composite, laminate, or coated material, film, composite, laminate, or the like Z-direction test methods, devices, instruments, equipment, apparatus, and/or systems. In accordance with at least particular possibly preferred embodiments, the present invention is directed to thin film Z-direction test methods, devices, instruments, equipment, apparatus, and/or systems. In accordance with at least certain particular possibly preferred embodiments, the present invention is directed to thin film Z-direction strength, penetration and/or compression test methods, devices, instruments, equipment, apparatus, and/or systems. In accordance with at least selected particular possibly preferred embodiments, the present invention is directed to high precision Micro-Penetration Strength Testers adapted for testing non-conductive thin films or membranes, and/or coated films or coated membranes, Micro-Compression Testers adapted for testing non-conductive thin films or membranes, and/or coated films or coated membranes, and/or the like. In accordance with at least selected certain particular possibly preferred embodiments, the present invention is directed to a high precision Micro-Penetration Strength Tester adapted for testing thin films, non-conductive thin films or membranes, and/or coated films or coated membranes, a high pressure Micro-Compression Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro Z-Direction Strength Tester adapted for testing thin films, non-conductive thin films or membranes, and/or coated films or coated membranes, a high precision Micro Z-Direction Tester adapted for testing thin films, non-conductive thin films or membranes, and/or coated films or coated membranes, and/or the like, a high precision Micro Tester adapted for testing thin films, non-conductive thin films or membranes, and/or coated films or coated membranes, a high precision Z-Direction Tester adapted for testing thin films, non-conductive thin films or membranes, and/or coated films or coated membranes, and/or the like. In accordance with at least selected other particular possibly preferred embodiments, the present invention is directed to high precision Nano Testers for testing non-conductive or semi-conductive materials, films, coatings, coated films, and/or the like, a Nano-Penetration Strength Tester adapted for testing thin films, non-conductive thin films or membranes, and/or coated films or coated membranes, a Nano-Compression Tester adapted for testing thin films, non-conductive thin films or membranes, and/or coated films or coated membranes, a high precision Nano-Penetration and/or Nano-Compression Tester adapted for testing thin films, non-conductive thin films or membranes, and/or coated films or coated membranes, and/or the like, a high precision Nano Z-Direction Strength Tester adapted for testing thin films, non-conductive thin films or membranes, and/or coated films or coated membranes, a high precision Nano Z-Direction Tester adapted for testing thin films, non-conductive thin films or membranes, and/or coated films or coated membranes, and/or the like, a high precision Nano Strength, Penetration and/or Compression Tester adapted for testing thin films, non-conductive thin films or membranes, and/or coated films or coated membranes, and/or the like. In accordance with at least certain selected particular possibly preferred embodiments, the present invention is directed to improved indenter tips, micro indenter tips, nano indenter tips, an indenter tip for converting a Micro-Penetration Strength Tester into a Micro-Compression Tester, an indenter tip for converting a Nano-Penetration Strength Tester into a Nano-Compression Tester, and/or the like. In accordance with at least selected certain particular possibly preferred embodiments, the present invention is directed to a high precision Micro-Penetration Z-Direction Strength Tester adapted for testing thin films, non-conductive thin films or membranes, and/or coated films or coated membranes, a high precision Micro-Compression Z-Direction Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro-Penetration and/or Micro-Compression Z-Direction Tester adapted for testing thin films, non-conductive thin films or membranes, and/or coated films or coated membranes, and/or the like. In accordance with at least certain other selected particular possibly preferred embodiments, the present invention is directed to methods of converting Micro-Penetration Strength Testers into Micro-Compression Testers, methods of converting Micro-Compression Testers into Micro-Penetration Strength Testers, methods of converting a Micro-Penetration Strength Tester into a Micro-Compression Tester by changing the indenter tip, by changing the shape of the indenter tip, and/or the like. In accordance with at least certain other selected particular possibly preferred embodiments, the present invention is directed to methods of converting Nano-Penetration Strength Testers into Nano-Compression Testers, methods of converting Nano-Compression Testers into Nano-Penetration Strength Testers, methods of converting a Nano-Penetration Strength Tester into a Nano-Compression Tester by changing the indenter tip, by changing the shape of the indenter tip, and/or the like.

In accordance with at least selected embodiments, the present invention is or inventions are directed to improved, unique, or specialized Z-direction test methods, devices, instruments, equipment, apparatus, and/or systems adapted for or especially well suited for testing thin films, single or multi-layer thin films, single or multi-ply thin films, composites, laminates, non-conductive materials, layers, or coatings, semi-conductive materials, layers, or coatings, micro-thin films, nano-thin films, and/or the like.

At least selected possibly preferred embodiments are directed to high precision Micro-Penetration Strength Testers, high pressure Micro-Compression Testers, and/or the like adapted for testing non-conductive thin films or membranes and coated films or coated membranes. At least certain embodiments are directed to Z-direction test methods, devices, instruments, equipment, apparatus, and/or systems, Micro-Penetration Strength Testers adapted for testing thin films, Micro-Compression Testers adapted for testing thin films, high precision Nano Testers for testing non-conductive or semi-conductive materials, films, coatings, coated films, and/or the like, Nano-Penetration Strength Testers, Nano-Compression Testers, Z-Direction Strength Testers, improved indenter tips, micro indenter tips, nano indenter tips, indenter tips for converting a Micro-Penetration Strength Tester into a Micro-Compression Tester, and/or the methods of converting Micro-Penetration Strength Testers into Micro-Compression Testers, methods of converting Micro-Compression Testers into Micro-Penetration Strength Testers, and/or methods of converting a Micro-Penetration Strength Tester into a Micro-Compression Tester by changing the indenter tip, by changing the shape of the indenter tip, and/or the like.

In accordance with at least selected embodiments, aspects, objects, or examples of the present invention, there is or are provided new, improved or specialized testing and/or measuring devices, instruments, equipment, apparatus, systems, components, and/or methods, mechanical and/or insulation strength testing and/or measuring devices, instruments, equipment, apparatus, systems, components, and/or methods, Z-direction or thickness-direction testing and/or measuring devices, instruments, equipment, apparatus, systems, components, and/or methods, Z-direction or thickness-direction strength testing and/or measuring devices, instruments, equipment, apparatus, systems, components, and/or methods, Z-direction or thickness-direction micro-penetration testing and/or measuring devices, instruments, equipment, apparatus, systems, components, and/or methods, and/or Z-direction test methods, devices, instruments, equipment, apparatus, and/or systems; non-conductive or semi-conductive materials, coatings or coated materials Z-direction testing and/or measuring methods, devices, instruments, equipment, apparatus, systems, and/or components, and/or non-conductive or semi-conductive materials, coatings or coated materials Z-direction test methods, devices, instruments, equipment, apparatus, and/or systems; non-conductive, polymer material, film or coating Z-direction testing and/or measuring methods, devices, instruments, equipment, apparatus, systems, and/or components, and/or non-conductive, polymer material, film or coating Z-direction test methods, devices, instruments, equipment, apparatus, and/or systems; non-conductive, polymer material, film, composite, or coated film Z-direction testing and/or measuring methods, devices, instruments, equipment, apparatus, systems, and/or components, and/or non-conductive, polymer material, film, composite, or coated film Z-direction test methods, devices, instruments, equipment, apparatus, and/or systems; porous, non-conductive, polymer material, film, composite, or coated film Z-direction test methods, devices, instruments, equipment, apparatus, and/or systems; porous, macroporous and/or microporous, non-conductive and/or semi-conductive, single or multi-layer, material, film, composite, laminate, or coated material, film, composite, laminate, or the like testing and/or measuring methods, devices, instruments, equipment, apparatus, systems, and/or components, and/or Z-direction test methods, devices, instruments, equipment, apparatus, and/or systems; thin film Z-direction test methods, devices, instruments, equipment, apparatus, and/or systems; thin film Z-direction strength, penetration, compression, micro penetration, and/or micro compression test methods, devices, instruments, equipment, apparatus, and/or systems; high precision Micro-Penetration Strength Testers adapted for testing non-conductive thin films or membranes, and/or coated films or coated membranes, Micro-Compression Testers adapted for testing non-conductive thin films or membranes, and/or coated films or coated membranes, and/or the like; high precision Micro-Penetration Strength Tester adapted for testing thin films, non-conductive thin films or membranes, and/or coated films or coated membranes, a high pressure Micro-Compression Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro Z-Direction Strength Tester adapted for testing thin films, non-conductive thin films or membranes, and/or coated films or coated membranes, a high precision Micro Z-Direction Tester adapted for testing thin films, non-conductive thin films or membranes, and/or coated films or coated membranes, and/or the like, a high precision Micro Tester adapted for testing thin films, non-conductive thin films or membranes, and/or coated films or coated membranes, a high precision Z-Direction Tester adapted for testing thin films, non-conductive thin films or membranes, and/or coated films or coated membranes, and/or the like; high precision Nano Testers for testing non-conductive or semi-conductive materials, films, coatings, coated films, and/or the like, a Nano-Penetration Strength Tester adapted for testing thin films, non-conductive thin films or membranes, and/or coated films or coated membranes, a Nano-Compression Tester adapted for testing thin films, non-conductive thin films or membranes, and/or coated films or coated membranes, a high precision Nano-Penetration and/or Nano-Compression Tester adapted for testing thin films, non-conductive thin films or membranes, and/or coated films or coated membranes, and/or the like, a high precision Nano Z-Direction Strength Tester adapted for testing thin films, non-conductive thin films or membranes, and/or coated films or coated membranes, a high precision Nano Z-Direction Tester adapted for testing thin films, non-conductive thin films or membranes, and/or coated films or coated membranes, and/or the like, a high precision Nano Strength, Penetration and/or Compression Tester adapted for testing thin films, non-conductive thin films or membranes, and/or coated films or coated membranes, and/or the like; indenter tips, micro indenter tips, nano indenter tips, an indenter tip for converting a Micro-Penetration Strength Tester into a Micro-Compression Tester, an indenter tip for converting a Nano-Penetration Strength Tester into a Nano-Compression Tester, and/or the like; high precision Micro-Penetration Z-Direction Strength Tester adapted for testing thin films, non-conductive thin films or membranes, and/or coated films or coated membranes, a high precision Micro-Compression Z-Direction Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro-Penetration and/or Micro-Compression Z-Direction Tester adapted for testing thin films, non-conductive thin films or membranes, and/or coated films or coated membranes, and/or the like; methods of converting Micro-Penetration Strength Testers into Micro-Compression Testers, methods of converting Micro-Compression Testers into Micro-Penetration Strength Testers, methods of converting a Micro-Penetration Strength Tester into a Micro-Compression Tester by changing the indenter tip, by changing the shape of the indenter tip, and/or the like; methods of converting Nano-Penetration Strength Testers into Nano-Compression Testers, methods of converting Nano-Compression Testers into Nano-Penetration Strength Testers, methods of converting a Nano-Penetration Strength Tester into a Nano-Compression Tester by changing the indenter tip, by changing the shape of the indenter tip, and/or the like; and/or the like.

### BRIEF DESCRIPTION OF THE DRAWINGS

FIG. 1 is a schematic side view illustration of the components of a possibly preferred device or system of at least one embodiment of the present invention such as a Micro-Penetration Tester.

FIG. 2 is a detailed or close-up photographic representation of an exemplary Micro-Penetration Strength Tester (or Micro-Compression Tester depending on the tip used and setup) in accordance with at least one embodiment or example of the present invention.

FIG. 3 is a photographic representation showing the overall setup of an exemplary Micro-Penetration Strength Tester system (or Micro-Compression Tester system) in accordance with at least one embodiment of the present invention. FIG. 2 is a more detailed view of a portion of the system of FIG. 3.

FIG. 4 is a graphical representation of an exemplary typical plot from the inventive Micro-Penetration Strength Tester where the maximum force is recorded as micro-penetration strength when the resistance suddenly drops off.

FIG. 5 is a graphical representation of a histogram plot showing the average Micro-Penetration Strength for a 20 um thick film over a two year period.

FIG. 6 is a graphical plot showing correlation data of thickness normalized micro penetration strength vs. film porosity (for a porous film sample).

FIG. 7 is a graphical representation of an example of a Micro-Compression test plot where pressure in psi is plotted as a function of % Compression for several thin film samples.

FIG. 8 is a graphical representation of data on Micro-Penetration Strength of ceramic coated and uncoated trilayer thin film samples.

### DETAILED DESCRIPTION OF THE INVENTION(S)

In accordance with at least selected embodiments, the present invention is directed to Z-direction test methods, devices, instruments, equipment, apparatus, and/or systems. In accordance with at least certain embodiments, the present invention is directed to non-conductive or semi-conductive materials or coatings Z-direction test methods, devices, instruments, equipment, apparatus, and/or systems. In accordance with at least particular embodiments, the present invention is directed to non-conductive, polymer material, film or coating Z-direction test methods, devices, instruments, equipment, apparatus, and/or systems. In accordance with at least possibly preferred embodiments, the present invention is directed to non-conductive, polymer material, film, composite, or coated film Z-direction test methods, devices, instruments, equipment, apparatus, and/or systems. In accordance with at least selected possibly preferred embodiments, the present invention is directed to porous, non-conductive, polymer material, film, composite, or coated film Z-direction test methods, devices, instruments, equipment, apparatus, and/or systems. In accordance with at least certain possibly preferred embodiments, the present invention is directed to microporous, non-conductive, polymer material, film, composite, or coated film Z-direction test methods, devices, instruments, equipment, apparatus, and/or systems. In accordance with at least particular possibly preferred embodiments, the present invention is directed to film Z-direction test methods, devices, instruments, equipment, apparatus, and/or systems. In accordance with at least certain particular possibly preferred embodiments, the present invention is directed to film Z-direction strength, penetration and/or compression test methods, devices, instruments, equipment, apparatus, and/or systems. In accordance with at least selected particular possibly preferred embodiments, the present invention is directed to high precision Micro-Penetration Strength Testers adapted for testing non-conductive thin films or membranes, and/or coated films or coated membranes, Micro-Compression Testers adapted for testing non-conductive thin films or membranes, and/or coated films or coated membranes, and/or the like. In accordance with at least selected certain particular possibly preferred embodiments, the present invention is directed to a high precision Micro-Penetration Strength Tester adapted for testing thin films, non-conductive thin films or membranes, and/or coated films or coated membranes, a Micro-Compression Tester adapted for testing thin films, non-conductive thin films or membranes, and/or coated films or coated membranes, a high precision Micro-Penetration and/or high pressure precision Micro-Compression Tester adapted for testing thin films, non-conductive thin films or membranes, and/or coated films or coated membranes, a high precision and/or high pressure Micro Z-Direction Strength Tester adapted for testing thin films, non-conductive thin films or membranes, and/or coated films or coated membranes, a high precision and/or high pressure Micro Z-Direction Tester adapted for testing thin films, non-conductive thin films or membranes, and/or coated films or coated membranes, and/or the like, a high precision and/or high pressure Micro Tester adapted for testing thin films, non-conductive thin films or membranes, and/or coated films or coated membranes, a high precision and/or high pressure Z-Direction Tester adapted for testing thin films, and/or the like. In accordance with at least selected other particular possibly preferred embodiments, the present invention is directed to high precision Nano Testers for testing non-conductive or semi-conductive materials, films, coatings, coated films, and/or the like, a Nano-Penetration Strength Tester adapted for testing thin films, non-conductive thin films or membranes, and/or coated films or coated membranes, a Nano-Compression Tester adapted for testing thin films, non-conductive thin films or membranes, and/or coated films or coated membranes, a high precision Nano-Penetration and/or high pressure Nano-Compression Tester adapted for testing thin films, non-conductive thin films or membranes, and/or coated films or coated membranes, and/or the like, a high precision Nano Z-Direction Strength Tester adapted for testing thin films, non-conductive thin films or membranes, and/or coated films or coated membranes, a high precision and/or high pressure Nano Z-Direction Tester adapted for testing thin films, non-conductive thin films or membranes, and/or coated films or coated membranes, and/or the like, a high precision and/or high pressure Nano Strength, Penetration and/or Compression Tester adapted for testing thin films, non-conductive thin films or membranes, and/or coated films or coated membranes, and/or the like. In accordance with at least certain selected particular possibly preferred embodiments, the present invention is directed to improved indenter tips, micro indenter tips, nano indenter tips, an indenter tip for converting a Micro-Penetration Strength Tester into a Micro-Compression Tester, an indenter tip for converting a Nano-Penetration Strength Tester into a Nano-Compression Tester, and/or the like. In accordance with at least selected certain particular possibly preferred embodiments, the present invention is directed to a high precision Micro-Penetration Z-Direction Strength Tester adapted for testing thin films, non-conductive thin films or membranes, and/or coated films or coated membranes, a high pressure or precision Micro-Compression Z-Direction Tester adapted for testing thin films, non-conductive thin films or membranes, and/or coated films or coated membranes, a high precision and/or high pressure Micro-Penetration and/or Micro-Compression Tester adapted for testing thin films, a high precision Micro-Penetration and/or Micro-Compression Z-Direction Tester adapted for testing thin films, and/or the like. In accordance with at least certain other selected particular possibly preferred embodiments, the present invention is directed to methods of converting Micro-Penetration Strength Testers into Micro-Compression Testers, methods of converting Micro-Compression Testers into Micro-Penetration Strength Testers, methods of converting a Micro-Penetration Strength Tester into a Micro-Compression Tester by changing the indenter tip, by changing the shape of the indenter tip, and/or the like. In accordance with at least certain other selected particular possibly preferred embodiments, the present invention is directed to methods of converting Nano-Penetration Strength Testers into Nano-Compression Testers, methods of converting Nano-Compression Testers into Nano-Penetration Strength Testers, methods of converting a Nano-Penetration Strength Tester into a Nano-Compression Tester by changing the indenter tip, by changing the shape of the indenter tip, and/or the like.

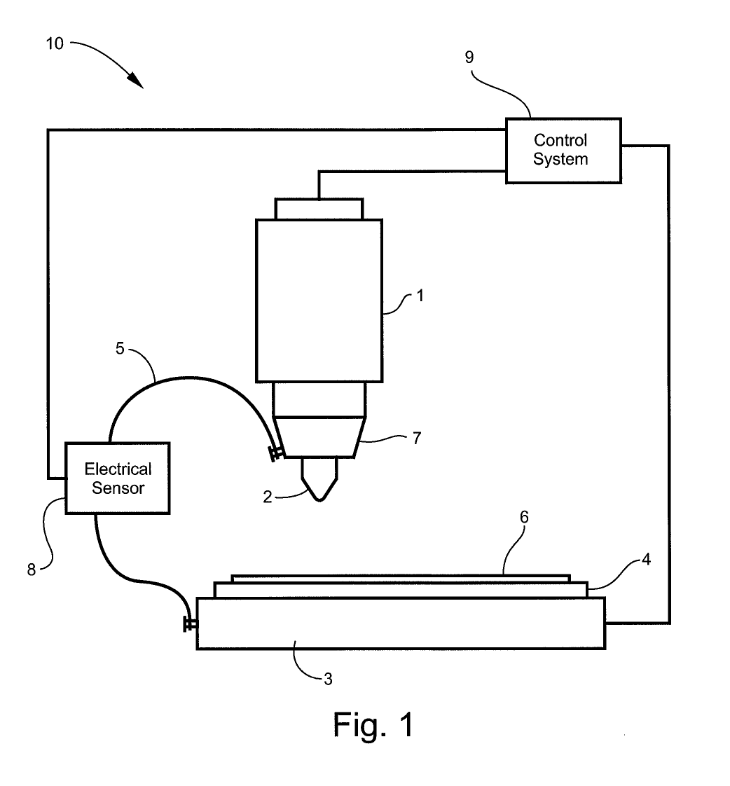

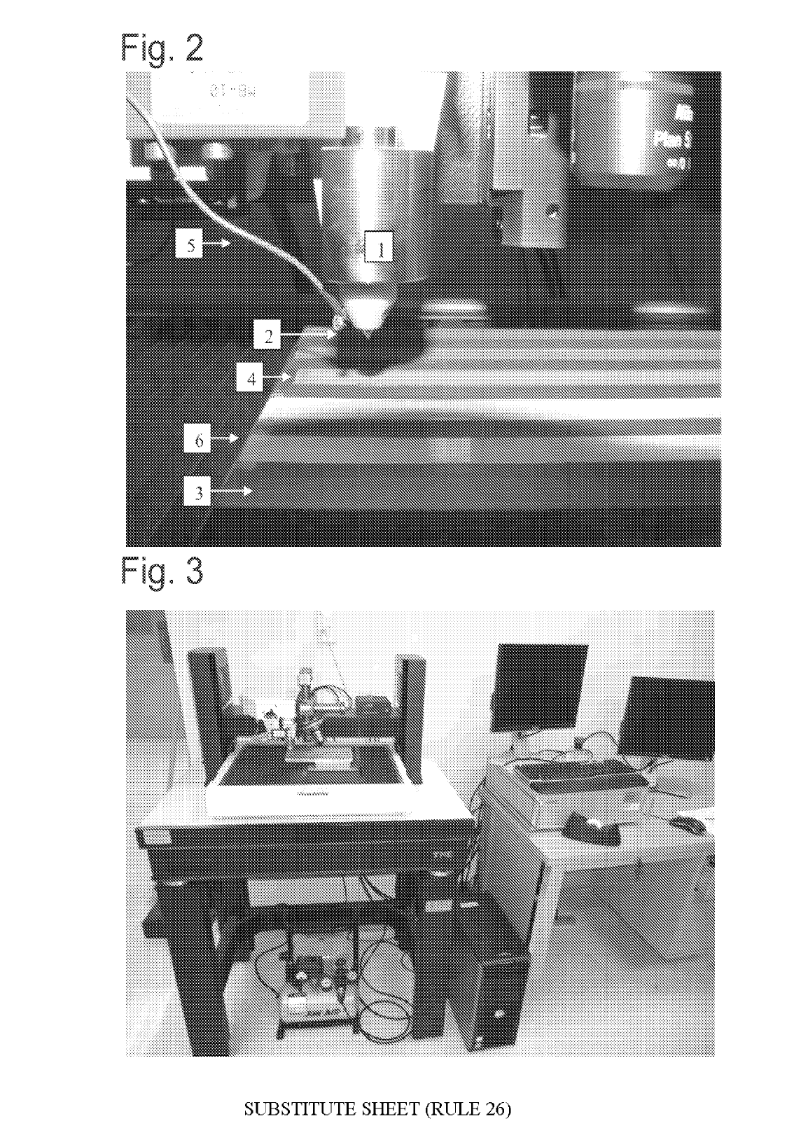

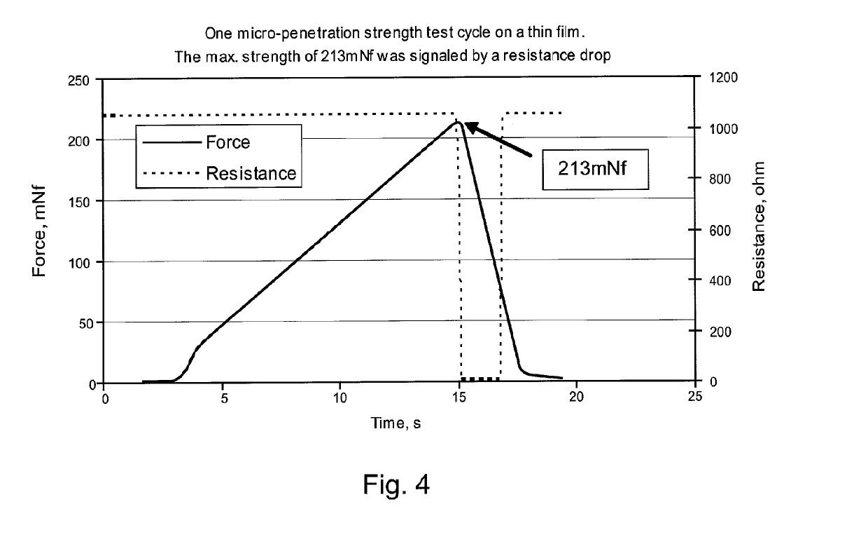

In accordance with at least selected embodiments of the present invention, and with reference to FIGS. 1, 2 and 3 of the drawings, a possibly preferred, exemplary Micro-Penetration Strength Testing system 10 such as a fully automated micro-indentation measuring or testing system, tester, instrument, device, or the like employs a testing or measuring head or device 1 such as a micro-indenter head, a conductive micron conical indenter 2, a test stage 3 such as a relatively large conductive test stage with micron surface finishes, a sample 6 such as one or more pieces or strips of non-conductive film, optional disposable conductive substrate 4 such as electro-plated metal (Cu for example) foil pieces or strips which serve as repeatable, uniform and disposable conductive substrates, and an electrical resistance measurement loop 5 between the indenter 2 and testing stage 3 (or between the indenter 2 and the conductive substrate 4) includes a sensor 8 such as an electrical resistance sensor, an elongate conductor or wire from the indenter 2 to the sensor 8 such as an insulated copper wire, another elongate conductor or wire from the stage 3 (or substrate 4) to the sensor 8, and preferably has respective conductive fasteners such as metal screws, bolts or studs for removably attaching the wires to the indenter and stage (the indenter fastener preferably passes through an insulative holder 7 and makes electrical contact with the indenter 2). To electrically insulate the indenter head 1 from the resistance measurement loop 5, the indenter holder 7 is made of ceramic or other non-conductive material. Signals or information from the resistance sensor 8 is sent to the central control system or CPU 9 for detecting the end point of a measurement or test. Each of the preferred system components 1 to 9 is shown schematically FIG. 1. A close-up photo of the testing or measuring components 1 to 7 of a particular or exemplary system 10 is shown in FIG. 2. An overall photo view of the particular or exemplary Micro-Penetration Strength testing system 10 of FIG. 2 with a large automatic X-Y translation stage 3, vibration proof air table supporting the stage, and PC control system 9 is shown in FIG. 3.

In accordance with a possibly preferred embodiment with reference to FIG. 1 or with reference to the possibly preferred example of FIGS. 2 and 3, testing or measuring is conducted, for example, by taping a ½″ wide×8″ long strip of the film sample 6 to a piece of copper foil 4 removably secured on the test stage 3. Then automatic testing starts, for example, with the indenter 2 detecting the film surface with a 10 mN force (mNf) first, then a compression force is applied at a rate of 250 mNf/min while the indenter penetrates the sample. The compression force in mNf and the penetration depth in microns are recorded continuously by the system or instrument 10. The maximum force at which the indenter 2 penetrates the non-conductive film sample 6 and makes contact with the conductive substrate 4 is noted or defined by a sudden drop of the electrical resistance between the indenter 2 and sample stage 3. For samples or films 6 with thickness ranging from 5-40 μm, a 60° conical indenter 2 with 10 μm radius spherical tip is preferred. Preferably, the force at which the micron conical indenter 2 penetrates the film sample 6 is measured automatically at one or more, preferably two or more, for example, thirty defined intervals along or on each sample or strip 6. The average of the multiple data points is reported as Micro-Penetration Strength of that sample. In accordance with the particular example of FIGS. 2 and 3, with the particular stage shown, a maximum of five different sample strips can be mounted at one time. Testing of all five such samples 6 can be conducted automatically through an X-Y matrix set up. Use of the substrate or substrates 4 protects the finish of the stage 3 and prevents damage to the head 1 and indenter 2 as the substrate 4 can deform or absorb the impact when the tip of the indenter 2 penetrates the sample 6 and contacts the substrate 4.

In accordance with at least selected embodiments of the present invention, the indenter tip shape of the Micro-Penetration Strength Tester can be changed from a spherical tip shape (or hemi-spherical) to a flat tip shape (to a flat end) by using different shaped indenters 2. Changing the shape of the indenter tip (changing out the indenter) converts the Micro-Penetration Tester into a Micro-Compression Tester. Because of the micron scale size of the indenter tip, for example, a spherical tip having a radius of less than about 50 μm may be preferred, of less than about 25 μm may be more preferred, of less than about 15 μm may be still more preferred, and of about 10 μm or less may be most preferred, or a flat tip having a width or diameter of less than about 500 μm may be preferred, of less than about 300 μm may be more preferred, of less than about 250 μm may be still more preferred, and of about 200 μm or less may be most preferred, penetration or compression test data can be obtained on a pressure scale that cannot be obtained using conventional testing equipment, using conventional testing methods, and/or the like. Because of the micron scale size of the flat indenter tip, compression test data can be obtained on a pressure scale that cannot be obtained using conventional compression testing equipment, using conventional compression testing methods, or using at least certain Thermal Mechanical Analysis (TMA) techniques. When the Micro-Penetration Tester is used as a Micro-Compression Tester, components 4 and 5 in FIGS. 1 and 2 may be optional.

In accordance with at least selected embodiments of the present invention, and with reference again to FIGS. 1, 2 and 3 of the drawings, a possibly preferred, exemplary Micro-Compression Testing system employs a fully automated micro-indentation tester (1), a conductive micron conical indenter (2) having a flat tip, and a micron surface finished test stage (3). When the Micro-Penetration Tester is used as a Micro-Compression Tester, components (4) and (5) in FIGS. 1 and 2 are optional and sample 6 can be taped down to test stage (3) directly. For example, the automatic compression testing starts when the indenter detects the film surface with a 10 mN force first, then a compression force is linearly applied by the indenter to the sample at a rate of 500 mN/min. The compression force in milli Newtons and the compression depth in microns are recorded and plotted continuously by the instrument. Traditional pressure (stress) vs. % compression (strain) plot can also be obtained if desired. End point of the test may be defined by the user either by desired pressure limit and % compression. For films with thickness ranging from 5-40 μm, a 120° conical indenter with 200 μm radius flat tip is preferred. Because of the preferred micron scale size of the indenter tip, compression test data can be obtained on a pressure scale that cannot be obtained using conventional compression testing equipment, using conventional compression testing methods, or using conventional Thermal Mechanical Analysis (TMA) techniques.

In accordance with at least selected embodiments of the present invention, the indenter tip shape of the Micro-Compression Tester is preferably a flat tip shape (has circular flat end; a truncated cone). Changing the shape of the indenter tip converts a Micro-Penetration Tester into a Micro-Compression Tester, or a Micro-Compression Tester to a Micro-Penetration Tester. Hence, a Micro Tester (or Micro Z-Direction Tester) that can run both Micro-Penetration and Micro-Compression Tests preferably includes a fully automated micro-indentation tester (1), a plurality of different shaped conductive micron sized tip conical indenters (2) preferably including at least one hemi-spherical shaped tip end indenter and at least one flat shaped tip end indenter, a large micron surface finished test stage (3), disposable conductive substrate (4), an Electrical Resistance measurement loop (5) adapted to go between the indenter (2) and testing stage (3), and a computer, PC, CPU or other programmable device for operating the system, recording the data, and the like. Because of the micron scale size of the indenter tip, penetration and/or compression measurement or test data can be obtained on a scale that cannot be obtained using conventional testing equipment, using conventional testing methods, and/or the like. When the Micro Tester is used as a Micro-Compression Tester, components (4) and (5) are optional.

In accordance with at least selected and possibly preferred embodiments of the present invention, an exemplary inventive Micro-Penetration Strength Testing system 10 is preferably a modified fully automated micro-indentation tester, device, instrument, or the like modified to include the inventive resistance measurement loop 5, indenters 2, disposable conductive substrates 4, and samples 6, and operated as described herein. For example, a modified micro hardness tester, modified compression tester, preferably a modified commercially available micro- or nano-indentation or hardness testing device, head or instrument. Preferred modifications may include: a conductive micron conical indenter (2), a large micron surface finished test stage (3), electroplated copper (or other metal) foil strips 4 as disposable, conductive substrates, an electrical resistance circuit (5) between the indenter (2) and testing stage (3), and/or the like. Each of these components is shown in FIG. 1.

Components 2, 3, 4 and 5 of the Micro-Penetration Strength Tester instrument are uniquely designed or adapted for non-conductive thin film testing such as for film or thin film testing. The preferred system also preferably includes a X, Y, Z direction displacement fully automated micro-indentation tester, a video microscope, a resistance measurement kit, a control module or controller, a CPU, PC or laptop computer, a keyboard, a display or monitor, an anti-vibration table, and/or the like. The present Micro-Penetration Strength Tester design and methodology can be used to test non-conductive or semi-conductive materials, films, thin films, coatings and/or the like in a variety of new high tech, high end, or niche applications in, for example, the semi-conductor, aero-space, medical, plastics, energy storage, filtration, and chemical industries. Examples of such applications include but are not limited to:
1. Non-conductive, semi-conductive materials, coatings or laminates for aero-space, semi-conductor, or electronics.
2. Packaging films or membranes for medical or food.
3. Porous polymer films or membranes.
4. New materials or polymers research and development
5. Special non-conductive, semi-conductive or insulative coatings or laminates for aero-space, semi-conductor, or electronic applications.

In testing for these applications, the coating would not need to be removed from the conductive substrate. Instead, the coated conductive or semi-conductive substrate would become part of the testing stage forming the resistance measurement loop (and may replace the substrate 4).

Since at least certain embodiments of the Micro-Penetration Strength Tester are adapted specifically for non-conductive material testing, it can also be called a Micro-Insulation Strength Tester.

Component 1 of the Micro-Penetration Strength Tester instrument shown in FIG. 1 is preferably the main component (table and head) of a modified commercially available micro- or nano-indentation tester, hardness tester, compression tester, or the like. The use of a fully automated indentation tester with X, Y matrix testing capability coupled with automatic Z direction displacement is preferred as it may guarantee the longevity of the micron indenter. Use of this preferred high precision micron indention instrument (with stable main frame) provides for a high quality, stable, long term, highly repeatable, improved, and standardized Micro-Penetration Strength test.

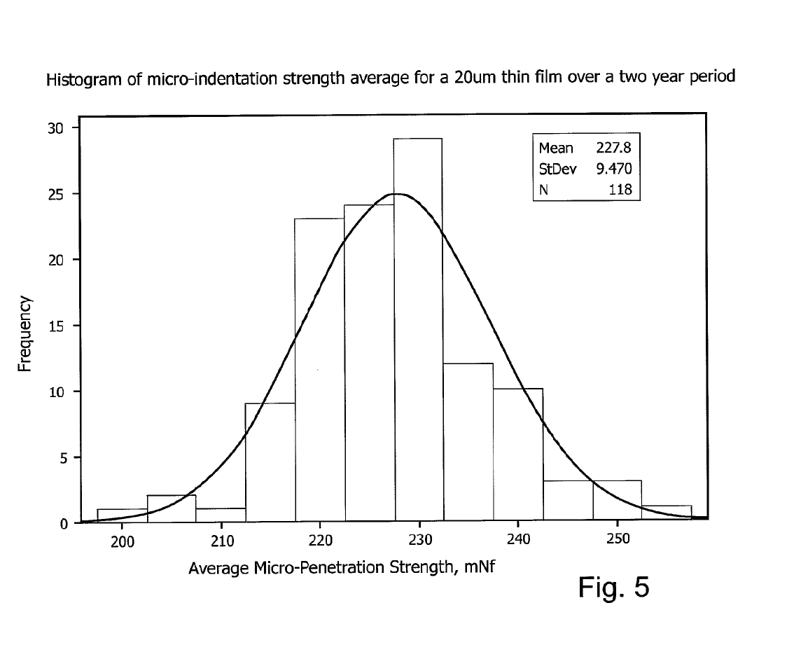

To demonstrate the high precision of the instrument over time, a histogram is shown in FIG. 5 of the average micro-penetration strength on a roll of 20 μm thin film collected over a period of more than two years. The low standard deviation of 9.47 mNf vs. average of 227.8 mNf indicates the high reliability of the inventive instrument design.

In the inventive Micro-Penetration Strength Tester mode, the maximum force at which the micron conical indenter tip penetrates the non-conductive film sample and makes contact with the conductive substrate on the testing stage is defined by a sudden drop of the Electrical Resistance. Therefore, the preferred indenter is made of a conductive material. Tungsten carbide was found to be the preferred and most economical material to make a long lasting indenter. Boron doped diamond works well as conductive indenter material, however, it may be more costly and difficult to machine into a conical shape.

The indenter tip shape and size are preferably selected to simulate the real particles. For example, if the typical particle size is around 10 μm in real field application, then preferably a 10 μm radius indenter tip is used for testing the film. For at least selected thin film testing, a 60° cone with 10 μm radius spherical tip was found to accurately simulate the particle penetration mechanism. In certain applications, not only is the indenter tip shape possibly critical, but the cone angle may also possibly be critical. Different cone angles result in different test results due to the unique dimensional stress imposed on the test sample by the indenter tip.

Table 1 shows that the relative strength of the tested thin films is dramatically different based on the shape of the indenter used.

TABLE 1
All indenters in Table 1 have 10 μm tip radius.

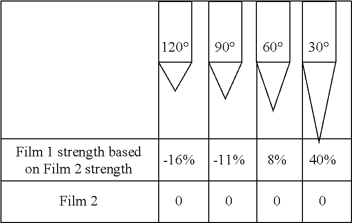

A possible advantage of the present Micro-Penetration Test over the earlier penetration tests is that the preferred present Micro-Penetration Test is a standardized particle penetration test that does not use particles. Also, the preferred present Micro-Penetration Test has long term stability and precision.

It was found that the higher the molecular weight of the polymer, the higher the Micro-Penetration strength. Although this is an expected outcome from polymer point of view, it is another confirmation of the validity of the test device and method. Table 2 shows Micro-Penetration test data for three thin films made from different molecular weight of polymer. Film Z with a molecular weight of 1,000,000 g/mol had the relative highest Micro-Penetration strength.

TABLE 2

| | | Micro- | Mix- |
|---|---|---|---|
| | Polymer | Penetration | Penetration, |
| Film Type | Mw | 60° Tip, mNf | Kgf |
| Film X | ~1,000,00 | 230 | 121 |
| Film Y | ~600,000 | 190 | 113 |
| Film Z | ~200,000 | 180 | 103 |

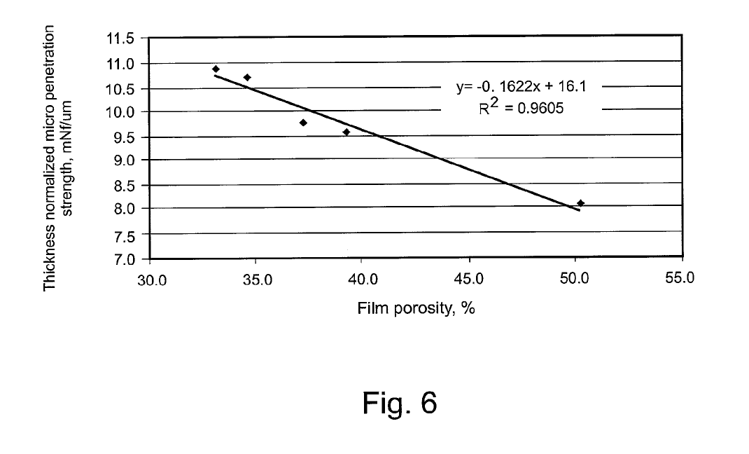

When the films are made of the same type(s) of polymer, their Micro-Penetration strength after thickness normalization was found inversely linear to Porosity where the porosity is defined as the void fraction in a microporous membrane or film. A correlation of higher Micro-Penetration strength after thickness normalization showing an inversely linear relationship with the porosity (FIG. 6) is an example of how Micro-Penetration strength test data may aid in the characterization of porous materials and may facilitate the development of future stronger film products.

In accordance with at least certain embodiments of the present invention, by changing the shape of the indenter tip from spherical to flat, the Micro-Penetration Tester is easily converted into a High Pressure Micro-Compression tester. When the Micro-Penetration Tester is used as a Micro-Compression Tester, components (4) and (5) in FIGS. 1 and 2 may not be needed or required. Because of the micron size of the indenter tip shape, this unique Micro-Compression Tester can obtain data beyond the capability of a typical compression test used for film performance testing. Table 3 contains the typical maximum compression pressure capability from a TMA and the inventive Micro-Compression Tester.

TABLE 3

| | Load | Tip Diameter, | Maximum |
|---|---|---|---|
| Instrument | cell, Nf | mm | Pressure, psi |
| TMA | 2 | 6 | 10 |
| Micro- | 30 | 0.2 | 138,566 |
| Compression | | | |

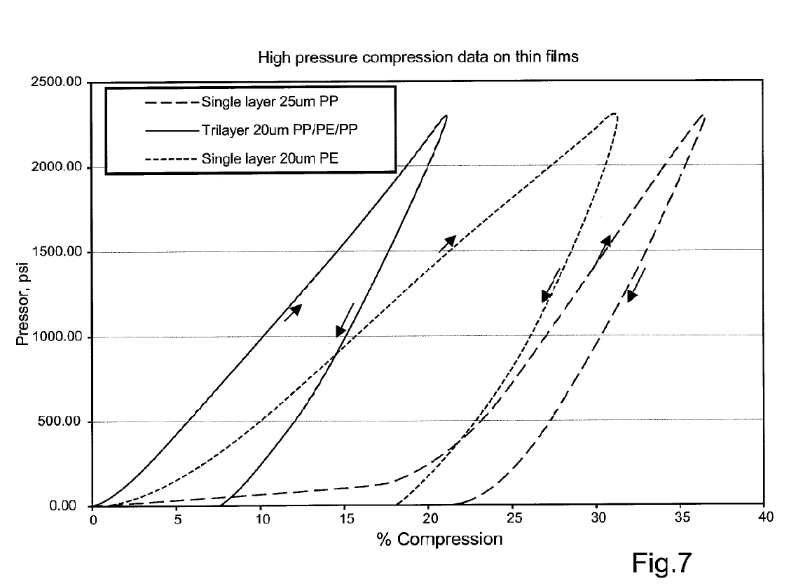

FIG. 7 provides an example of high pressure Micro-Compression Test data on selected thin films measured at the settings listed in Table 4. The data in FIG. 7 shows that one film is more easily compressed than the other. As a result, at least certain films may perform better under high pressure stacking processes.

TABLE 4

| Parameter | Setting | Unit |
|---|---|---|
| Contact load: | 10 | mN |
| Indenter speed: | 62.25 | um/min |
| Max load: | 500 | mN |
| Loading rate: | 500 | mN/min |
| Holding time at max load: | 0 | s |
| Unloading rate: | 500 | mN/min |
| Indenter diameter: | 200 | um |
| Data rate: | 15 | Hz |

Another significant advantage of the preferred Micro-Compression Tester over TMA testing is that the Micro-Compression Tester provides Elastic Recovery data followed by compression as shown in the return curve in FIG. 7. This type of data may be extremely useful in certain manufacturing processes.

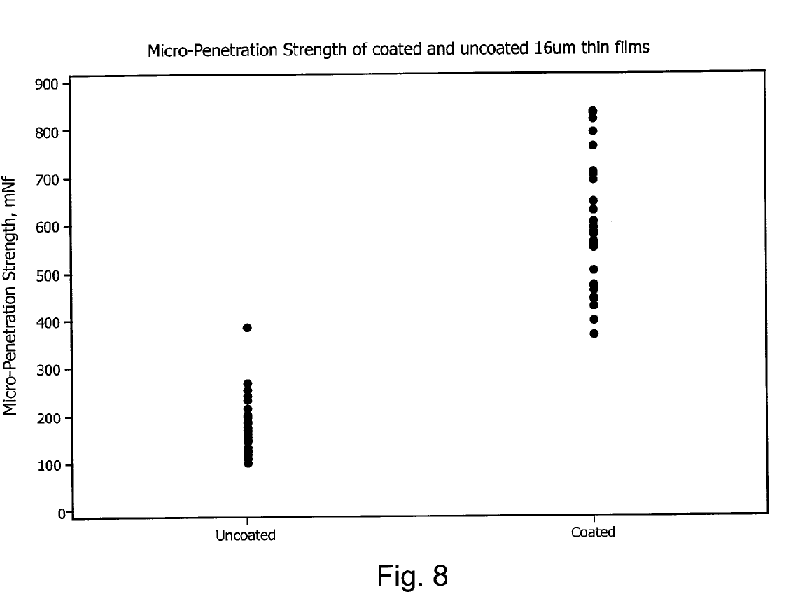

The present Micro-Penetration Strength Tester has been used for testing the mechanical insulation strength of at least certain coated films, such as ceramic coated thin films for High Temperature applications. The Z-direction penetration strength was measured on ceramic coated and uncoated 16 μm trilayer films. The Micro-Penetration Strength Test data shown in FIG. 8 indicates that a ceramic coating can dramatically increase the strength of a base film or membrane.

Potential applications of the inventive Micro-Penetration Tester and/or the inventive Micro-Compression Tester include but are not limited to:
1. Certain Aero-Space and Military specialty polymer coatings designed to improve the surface properties such as:

Coefficient of Friction

Chemical & Corrosion Resistance

Electric Insulation

Wear Resistance

Heat Resistance

Non-Wetting

Oxidation Barriers

Fire Retardants
These specialty coatings can be tested using the present Micro-Penetration Strength Tester to simulate the potential particle collision damage when entering earth's atmosphere or in outer space. These specialty coatings are widely used for surface treatment of the interior or exterior of aircrafts, space shuttles, military tactical vehicles, weapons, and missile systems.
2. Medical:

Artificial joints:
A polyethylene bearing surface is normally used on the top of the conductive metallic portion of the prosthesis in artificial joints. The Micro-Penetration Strength Tester can be used to test the strength of this surface against potential small bone fragments or metal particles caused by wearing and the stress of the joints.

Medical pouches or bags:
The Micro-Penetration Strength Tester can be used to simulate sharp object or needle penetration into medical plastic pouches or bags.
3. Semiconductor and Electronics
   The semi-conductor industry may be using micro- or nano-indentation testers for mechanical hardness testing. The additional components in the present inventive Micro-Penetration Strength Testers widen the capabilities for testing non-conductive, semi-conductive or electrical insulation strength of photo resist coating layers and oxide insulation layers in wafer micro-fabrication. In the electronics material industry, the present Micro-Penetration Strength Tester can very effectively be used to test the mechanical insulation strength of the sheet capacitor materials.
4. Automobile
   Paint applied in automobile applications involves coating metallic surfaces. The inventive Micro-Penetration Strength Tester can be used to test the penetration strength of the coating. A scratch-type tester is currently in use in the automobile industry to test the adhesion of the paint or coatings. The Micro-Penetration Strength Tester provides an alternative mode of testing where the direction of the force applied is different. In addition, the scratch tester does not have the electrical resistance measurement loop found in the present Micro-Penetration Strength Tester which provides improved accuracy in detecting the ending point of the test.
5. Academic Study in Polymer and Material Science
   Because the inventive Micro-Penetration Strength Tester is the first of its kind to accurately measure Z-direction particle penetration strength of a non-conductive material, it can be used as an R&D tool in many universities or research institutions studying new polymeric and other materials.
6. Other
   The Micro-Penetration Strength Tester is not limited to testing single layer film or coated single layer films. As long as each individual layer has a different electrical resistance, the Micro-Penetration Strength Tester can discern the mechanical and insulation strength of each layer.

### Expanded Potential of the Present Testing Instrument Designs:

Nano-Penetration and/or Compression Tester:

By changing the main instrument frame (for example of FIGS. 1 & 2) from Micro- to Nano-Indentation so it would able to handle accurate displacement in nanometer in X, Y and Z directions, reducing the indenter size from micro to nanometers, in addition, adopting nanometer surface finished substrate and testing stage, the inventive tester would become a Nano-Penetration or Compression Tester which could have potential even wider application in the semiconductor wafer micro fabrication process.
High or Low Temperature Micro-Penetration or Compression Tester:
With sophisticated changes in design and careful selection of material for each tester component in FIGS. 1 & 2, a heated or cooled chamber could be added to the equipment for high or low temperature related insulation, penetration or compression testing.
Thermo Mechanical Analyzer (TMA) with Insulation Strength Test Capability:
Rather than adding the heated chamber capability to the Micro-Penetration or Compression Tester, modification of adding conductive probe, stage to create a measurement loop for resistance, such a modified TMA could gain the present capability for measuring the insulation strength of a non-conductive material.

In accordance with at least selected embodiments, the present invention is directed to a high precision Micro-Penetration Strength Tester designed for testing non-conductive thin films or membranes and coated films or coated membranes. The Micro-Penetration Strength Tester can be converted into a Micro-Compression Tester by changing the shape of the indenter tip.

In accordance with at least selected embodiments of the present invention, the indenter tip shape of the Micro-Penetration Strength Tester can be changed from a spherical to flat tip shape (to a flat end). Changing the shape of the indenter tip converts the Micro-Penetration Tester into a Micro-Compression Tester. Because of the micron scale size of the indenter tip, compression test data can be obtained on a pressure scale that cannot be obtained using conventional compression testing equipment, using conventional compression testing methods, or using Thermal Mechanical Analysis (TMA) techniques. When the Micro-Penetration Tester is used as a Micro-Compression Tester, components (4) and (5) in FIG. 1 are not needed, or not required.

In accordance with at least selected embodiments of the present invention, and with reference again to FIGS. 1, 2 and 3 of the drawings, a possibly preferred, exemplary Micro-Compression Testing system employs a fully automated micro-indentation tester (1), a conductive micron conical indenter (2) having a flat tip, and a micron surface finished test stage (3). Each of these components is shown in FIGS. 1 & 2. When the Micro-Penetration Tester is used as a Micro-Compression Tester, components (4) and (5) in FIGS. 1 & 2 are optional. Samples 6 can be taped down to test stage (3) directly. The automatic compression testing starts when the indenter detects the film surface with a 10 mN force first, then a compression force is linearly applied by the indenter to the sample at a rate of 500 mN/min. The compression force in milli Newtons and the compression depth in microns are recorded and plotted continuously by the instrument. Traditional pressure (stress) vs. % compression (strain) plot can also be obtained if desired. End point of the test may be defined by the user either by desired pressure limit and % compression. For films with thickness ranging from 5-40 μm, a 120° conical indenter with 200 μm radius flat tip may be preferred. Because of the preferred micron scale size of the indenter tip, compression test data can be obtained on a pressure scale that cannot be obtained using conventional compression testing equipment, using conventional compression testing methods, or using conventional Thermal Mechanical Analysis (TMA) techniques.

In accordance with at least selected embodiments of the present invention, the indenter tip shape of the Micro-Compression Tester is preferably a flat tip shape (has circular flat end). Changing the shape of the indenter tip converts a Micro-Penetration Tester into a Micro-Compression Tester, or a Micro-Compression Tester to a Micro-Penetration Tester. Hence, a Micro Tester (or Micro Z-Direction Tester) that can run both Micro-Penetration and Micro-Compression Tests includes a fully automated micro-indentation tester (1), a plurality of different shaped conductive micron sized tip conical indenters (2) preferably including at least one hemi-spherical shaped tip end indenter and at least one flat shaped tip end indenter, a large micron surface finished test stage (3), disposable conductive substrate (4), an Electrical Resistance input loop (5) adapted to go between the indenter (2) and testing stage (3), and a computer or other programmable device for operating the system, recording the data, and the like. Because of the micron scale size of the indenter tip, penetration and/or compression test data can be obtained on a scale that cannot be obtained using conventional testing equipment, using conventional testing methods, and/or the like. When the Micro Tester is used as a Micro-Compression Tester, components (4) and (5) are not required.

At least selected possibly preferred embodiments are directed to high precision Micro-Penetration Strength Testers, high pressure Micro-Compression Testers, and/or the like adapted for testing non-conductive thin films or membranes and coated films or coated membranes. At least certain embodiments are directed to Z-direction test methods, devices, instruments, equipment, apparatus, and/or systems, Micro-Penetration Strength Testers adapted for testing films, Micro-Compression Testers adapted for testing films, high precision Nano Testers for testing non-conductive or semi-conductive materials, films, coatings, coated films, and/or the like, Nano-Penetration Strength Testers, Nano-Compression Testers, Z-Direction Strength Testers, improved indenter tips, micro indenter tips, nano indenter tips, indenter tips for converting a Micro-Penetration Strength Tester into a Micro-Compression Tester, and/or the methods of converting Micro-Penetration Strength Testers into Micro-Compression Testers, methods of converting Micro-Compression Testers into Micro-Penetration Strength Testers, and/or methods of converting a Micro-Penetration Strength Tester into a Micro-Compression Tester by changing the indenter tip, by changing the shape of the indenter tip, and/or the like.

At least selected embodiments are directed to:

An improved, unique, or specialized method, devices, instruments, equipment, apparatus, and/or system for at least certain applications, materials, and/or the like, to conduct standardized micro particle penetration testing without the use of particles, for specialized micro particle penetration testing without the use of particles, for repeatable and/or consistent micro particle penetration testing without the use of particles, for repeatable and/or consistent standardized micro particle penetration testing without the use of particles, to conduct standardized high pressure compression testing, to conduct standardized Z-direction mechanical and electrical insulation testing, and/or improved testing methods, devices, instruments, equipment, apparatus, and/or systems, and/or the like.

A design, method, devices, instruments, equipment, apparatus, and/or system to conduct standardized micro particle penetration testing without the use of particles, for specialized micro particle penetration testing without the use of particles, for repeatable and/or consistent micro particle penetration testing without the use of particles, for repeatable and/or consistent standardized micro particle penetration testing without the use of particles, to conduct standardized micro compression testing, for repeatable and/or consistent compression testing, for repeatable and/or consistent standardized micro compression testing, to conduct standardized Z-direction Mechanical and Electrical Insulation Strength testing, for repeatable and/or consistent Z-direction Mechanical and Electrical Insulation Strength testing, for repeatable and/or consistent standardized Z-direction Mechanical and Electrical Insulation Strength testing, and/or improved testing methods, devices, instruments, equipment, apparatus, and/or systems, and/or the like.

Z-direction Mechanical and Electrical Insulation Strength test methods, devices, instruments, equipment, apparatus, and/or systems, non-conductive or semi-conductive materials or coatings Z-direction Mechanical and Electrical Insulation Strength test methods, devices, instruments, equipment, apparatus, and/or systems, non-conductive, polymer material, film or coating Z-direction Mechanical and Electrical Insulation Strength test methods, devices, instruments, equipment, apparatus, and/or systems, non-conductive, polymer material, film, composite, or coated film Z-direction Mechanical and Electrical Insulation Strength test methods, devices, instruments, equipment, apparatus, and/or systems, porous, non-conductive, polymer material, film, composite, or coated film Z-direction Mechanical and Electrical Insulation Strength test methods, devices, instruments, equipment, apparatus, and/or systems, microporous, non-conductive, polymer material, film, composite, or coated film Z-direction Mechanical and Electrical Insulation Strength test methods, devices, instruments, equipment, apparatus, and/or systems, film Z-direction Mechanical and Electrical Insulation Strength test methods, devices, instruments, equipment, apparatus, and/or systems, film Z-direction Mechanical and Electrical Insulation Strength strength, penetration and/or compression test methods, devices, instruments, equipment, apparatus, and/or systems, high precision Micro-Penetration Strength Testers adapted for testing non-conductive thin films or membranes, and/or coated films or coated membranes, high pressure Micro-Compression Testers adapted for testing non-conductive thin films or membranes, and/or coated films or coated membranes, and/or the like, a high precision Micro-Penetration Strength Tester adapted for testing films, non-conductive thin films or membranes, and/or coated films or coated membranes, a Micro-Compression Tester adapted for testing films, non-conductive thin films or membranes, and/or coated films or coated membranes, a high precision and/or high pressure Micro-Penetration and/or Micro-Compression Tester adapted for testing thin films, non-conductive thin films or membranes, and/or coated films or coated membranes, a high precision and/o high pressure Micro Z-Direction Mechanical and Electrical Insulation Strength Tester adapted for testing films, non-conductive films, and/or coated films, a high precision and/or pressure Micro Z-Direction Mechanical and Electrical Insulation Strength Tester adapted for testing films, and/or the like, a high precision Micro Tester adapted for testing films or coatings, and/or a high precision or pressure Z-Direction Mechanical and Electrical Insulation Strength Tester adapted for films, coatings, laminates, composites, layers, and/or the like.

High precision Nano Testers for testing non-conductive or semi-conductive materials, films, coatings, coated films, and/or the like, a Nano-Penetration Strength Tester adapted for testing films, non-conductive thin films or membranes, and/or coated films or coated membranes, a Nano-Compression Tester adapted for testing films, non-conductive thin films or membranes, and/or coated films or coated membranes, a high precision Nano-Penetration and/or Nano-Compression Tester adapted for testing films, non-conductive thin films or membranes, and/or coated films or coated membranes, and/or the like, a high precision Nano Z-Direction Strength Tester adapted for testing films, non-conductive thin films or membranes, and/or coated films or coated membranes, a high precision Nano Z-Direction Tester adapted for testing films, non-conductive thin films or membranes, and/or coated films or coated membranes, and/or the like, and/or a high precision Nano Strength, Penetration and/or Compression Tester adapted for testing films, coatings, non-conductive thin films or membranes, and/or coated films or coated membranes, and/or the like.

Improved indenter tips, micro indenter tips, nano indenter tips, an indenter tip for converting a Micro-Penetration Strength Tester into a Micro-Compression Tester, and/or the like.

A high precision Micro-Penetration Z-Direction Strength Tester adapted for testing films, non-conductive thin films or membrane, and/or coated films or coated membranes, a high pressure Micro-Compression Z-Direction Tester adapted for testing films, a high precision Micro-Penetration and/or Micro-Compression Tester adapted for testing films, and/or a high precision Micro-Penetration and/or Micro-Compression Z-Direction Tester adapted for testing films, and/or the like.

Methods of converting Micro-Penetration Strength Testers into Micro-Compression Testers, methods of converting Micro-Compression Testers into Micro-Penetration Strength Testers, and/or methods of converting a Micro-Penetration Strength Tester into a Micro-Compression Tester by changing the indenter tip, by changing the shape of the indenter tip, and/or the like.

High precision Micro-Penetration Strength Testers, high pressure Micro-Compression Testers, and/or the like adapted for testing non-conductive thin films or membranes and coated films or coated membranes.

Z-direction test methods, devices, instruments, equipment, apparatus, and/or systems, Micro-Penetration Strength Testers adapted for testing films, Micro-Compression Testers adapted for testing films, high precision Nano Testers for testing non-conductive or semi-conductive materials, films, coatings, coated films, and/or the like, Nano-Penetration Strength Testers, Nano-Compression Testers, Z-Direction Strength Mechanical and Insulation Strength Testers, improved indenter tips, micro indenter tips, nano indenter tips, indenter tips for converting a Micro-Penetration Strength Tester into a Micro-Compression Tester, and/or the methods of converting Micro-Penetration Strength Testers into Micro-Compression Testers, methods of converting Micro-Compression Testers into Micro-Penetration Strength Testers, and/or methods of converting a Micro-Penetration Strength Tester into a Micro-Compression Tester by changing the indenter tip, by changing the shape of the indenter tip, and/or the like.

In accordance with at least selected embodiments, aspects, objects, or examples of the present invention, there is or are provided new or improved testing and/or measuring devices, instruments, equipment, apparatus, systems, components, and/or methods, mechanical and/or insulation strength testing and/or measuring devices, instruments, equipment, apparatus, systems, components, and/or methods, Z-direction or thickness-direction testing and/or measuring devices, instruments, equipment, apparatus, systems, components, and/or methods, Z-direction or thickness-direction strength testing and/or measuring devices, instruments, equipment, apparatus, systems, components, and/or methods, Z-direction or thickness-direction micro-penetration testing and/or measuring devices, instruments, equipment, apparatus, systems, components, and/or methods, and/or Z-direction test methods, devices, instruments, equipment, apparatus, and/or systems; non-conductive or semi-conductive materials, coatings or coated materials Z-direction testing and/or measuring methods, devices, instruments, equipment, apparatus, systems, and/or components, and/or non-conductive or semi-conductive materials, coatings or coated materials Z-direction test methods, devices, instruments, equipment, apparatus, and/or systems; non-conductive, polymer material, film or coating Z-direction testing and/or measuring methods, devices, instruments, equipment, apparatus, systems, and/or components, and/or non-conductive, polymer material, film or coating Z-direction test methods, devices, instruments, equipment, apparatus, and/or systems; non-conductive, polymer material, film, composite, or coated film Z-direction testing and/or measuring methods, devices, instruments, equipment, apparatus, systems, and/or components, and/or non-conductive, polymer material, film, composite, or coated film Z-direction test methods, devices, instruments, equipment, apparatus, and/or systems; porous, non-conductive, polymer material, film, composite, or coated film Z-direction test methods, devices, instruments, equipment, apparatus, and/or systems; porous, macroporous and/or microporous, non-conductive and/or semi-conductive, single or multi-layer, material, film, composite, laminate, or coated material, film, composite, laminate, or the like testing and/or measuring methods, devices, instruments, equipment, apparatus, systems, and/or components, and/or Z-direction test methods, devices, instruments, equipment, apparatus, and/or systems; thin film Z-direction test methods, devices, instruments, equipment, apparatus, and/or systems; thin film Z-direction strength, penetration, compression, micro penetration, and/or micro compression test methods, devices, instruments, equipment, apparatus, and/or systems; high precision Micro-Penetration Strength Testers adapted for testing non-conductive thin films or membranes, and/or coated films or coated membranes, Micro-Compression Testers adapted for testing non-conductive thin films or membranes, and/or coated films or coated membranes, and/or the like; high precision Micro-Penetration Strength Tester adapted for testing thin films, non-conductive thin films or membranes, and/or coated films or coated membranes, a high pressure Micro-Compression Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro Z-Direction Strength Tester adapted for testing thin films, non-conductive thin films or membranes, and/or coated films or coated membranes, a high precision Micro Z-Direction Tester adapted for testing thin films, non-conductive thin films or membranes, and/or coated films or coated membranes, and/or the like, a high precision Micro Tester adapted for testing thin films, non-conductive thin films or membranes, and/or coated films or coated membranes, a high precision Z-Direction Tester adapted for testing thin films, non-conductive thin films or membranes, and/or coated films or coated membranes, and/or the like; high precision Nano Testers for testing non-conductive or semi-conductive materials, films, coatings, coated films, and/or the like, a Nano-Penetration Strength Tester adapted for testing thin films, non-conductive thin films or membranes, and/or coated films or coated membranes, a Nano-Compression Tester adapted for testing thin films, non-conductive thin films or membranes, and/or coated films or coated membranes, a high precision Nano-Penetration and/or Nano-Compression Tester adapted for testing thin films, non-conductive thin films or membranes, and/or coated films or coated membranes, and/or the like, a high precision Nano Z-Direction Strength Tester adapted for testing thin films, non-conductive thin films or membranes, and/or coated films or coated membranes, a high precision Nano Z-Direction Tester adapted for testing thin films, non-conductive thin films or membranes, and/or coated films or coated membranes, and/or the like, a high precision Nano Strength, Penetration and/or Compression Tester adapted for testing thin films, non-conductive thin films or membranes, and/or coated films or coated membranes, and/or the like; indenter tips, micro indenter tips, nano indenter tips, an indenter tip for converting a Micro-Penetration Strength Tester into a Micro-Compression Tester, an indenter tip for converting a Nano-Penetration Strength Tester into a Nano-Compression Tester, and/or the like; high precision Micro-Penetration Z-Direction Strength Tester adapted for testing thin films, non-conductive thin films or membranes, and/or coated films or coated membranes, a high precision Micro-Compression Z-Direction Tester adapted for testing thin films, non-conductive thin films or membranes, and/or coated films or coated membranes, a high precision Micro-Penetration and/or Micro-Compression Tester adapted for testing thin films, non-conductive thin films or membranes, and/or coated films or coated membranes, a high precision Micro-Penetration and/or Micro-Compression Z-Direction Tester adapted for testing thin films, non-conductive thin films or membranes, and/or coated films or coated membranes, and/or the like; methods of converting Micro-Penetration Strength Testers into Micro-Compression Testers, methods of converting Micro-Compression Testers into Micro-Penetration Strength Testers, methods of converting a Micro-Penetration Strength Tester into a Micro-Compression Tester by changing the indenter tip, by changing the shape of the indenter tip, and/or the like; methods of converting Nano-Penetration Strength Testers into Nano-Compression Testers, methods of converting Nano-Compression Testers into Nano-Penetration Strength Testers, methods of converting a Nano-Penetration Strength Tester into a Nano-Compression Tester by changing the indenter tip, by changing the shape of the indenter tip, and/or the like; and/or the like.

The present invention may be embodied in other forms without departing from the spirit and the essential attributes thereof, and, accordingly, reference should be made to the appended claims, rather than to the foregoing specification, as indicated in the scope of the invention.

1-9. (canceled)

10. A penetration/compression testing system comprising an indenter moveable in a Z direction, an electrical resistance loop between the indenter and a sample stage moveable in an X-Y plane sized to carry multiple insulating, nonconductive or semi-conductive samples, whereby testing is performed at multiple locations on a first sample and thereafter repeated on another sample on the sample stage.

11. A method for conducting reproducible testing using the system of claim 10 wherein the resistance loop determines the end point.

12. The system of claim 10 wherein the indenter is a conductive micro-indenter and includes a tip and the tip being a spherical tip or a flat tip.

13. The system of claim 12 wherein the spherical tip having a radius of less than 50 microns.

14. The system of claim 12 wherein the flat tip having a width of less than 500 microns.

15. The system of claim 10 wherein the indenter being interchangeable.

16. A testing system comprising: a testing head moveable in a Z direction, a conductive micron conical indenter, a test stage moveable in a X-Y plane and adapted to support one or more thin insulating, nonconductive or semi-conductive test samples, and an electrical resistance measurement loop between the testing head and testing stage including a sensor.

17. The system of claim 16 further comprising an indenter head carried by the testing head.

18. The testing system of claim 17 wherein the indenter head being a micro indenter head.

19. The testing system of claim 18 wherein the micro indenter head being a conductive micron conical indenter.

20. The testing system of claim 16 wherein the test stage includes a disposable conductive substrate.

21. The testing system of claim 20 wherein the disposable conductive substrate being an electroplated strip.

22. The testing system of claim 16 wherein the sensor being an electrical resistance sensor.
